(19) United States
(12) Patent Application Publication
(10) Pub. No.: US 2007/0070187 A1
(43) Pub. Date: Mar. 29, 2007

(54) Television with built-in digital video recording device

(76) Inventors: Wu-Hung Lin, Chung Ho City (TW); Chien-Chih Wu, Chung Ho City (TW); Hsin-Chuan Liu, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/293,138

(22) Filed: Dec. 5, 2005

(30) Foreign Application Priority Data
Sep. 27, 2005 (TW) 94216657

(51) Int. Cl. H04N 7/14; H04N 7/18; H04N 9/47

(52) U.S. Cl. 348/14.04; 348/143

(57) ABSTRACT

A television with a built-in digital video recording device includes: an image receiving unit, receiving digital images from external cameras; an audio/video processing unit, processing the digital images and sound signals picked up by microphones, and outputting audio/video signals; a storage unit, storing the audio/video signals; a central processing unit, receiving and processing the audio/video signals and external television signals; and a display unit, presenting the sound and images of the audio/video signals or the television signals. The television with a built-in digital video recording device of the present invention not only has amusement, security monitoring, and digital video recording functions simultaneously but also has small size and high space efficiency.

### BACKGROUND OF THE INVENTION

1. Field of the Invention

The present invention relates to a television device, particularly to a television with a built-in digital video recording device, which has amusement, security monitoring, and digital video recording functions simultaneously.

2. Description of the Related Art

Although there are security personnel protecting the safety of a commercial building or a residential community/apartment, there are still safety gaps because either the guard area is too large or the on-duty security guard has to leave his seat to patrol, to deal with an incident, or even to the toilet. Therefore, electronic security equipments become the basic instruments of a security task and assist security guards in monitoring, controlling, and alarming.

In general, no matter whether a security system is to be installed in a shop, a residence, or a community, the security system needs to be installed by professional technicians. The security system used in a residential apartment or a commercial building is far more complicated, and its installation is hard and expensive. In addition to the cameras installed in the monitored regions, entrances and exits, a digital video recorder is usually used to record the images captured by the cameras. The captured images are also watched on a monitor in real time. When the user wants to watch a TV program in his spare time, he needs a television future. However, an extra television installed in the environment where the digital video recorder and the monitors have been installed occupies extra space, which will reduce the space efficiency, and in the crowded urban environment, it is important to utilize space efficiently.

Accordingly, the present invention proposes a television with a built-in digital video recording device to overcome the problems of difficult and expensive installation and small space efficiency in the conventional security system.

### SUMMARY OF THE INVENTION

One of the objectives of the present invention is to provide a television with a built-in digital video recording device, which integrates a television, a monitor, and a digital video recorder into a unitary device and has amusement, security monitoring, and digital video recording functions by a remote control bar.

One of the objectives of the present invention is to provide a television with a built-in digital video recording device, which integrates three devices into a unitary one and has small size and high space efficiency.

One of the objectives of the present invention is to provide a television with a built-in digital video recording device, wherein the assembly thereof is easy and rapid, and the installation expense can be saved thereby.

To achieve the above mentioned objectives, the present invention proposes a television with a built-in digital video recording device including: an image receiving unit, receiving and processing digital images from external cameras; an audio/video processing unit, compressing, partitioning the digital images, and outputting video signals to a storage unit and a central processing unit; a storage unit, storing the video signals; a central processing unit, receiving and processing the video signals and external television signals; and a display unit, presenting the images of the video signals or the television signals.

To enable the objectives, technical contents, characteristics, and accomplishments of the present invention, the embodiments of the present invention are to be described below in detail in cooperation with the attached drawings.

### BRIEF DESCRIPTION OF THE DRAWINGS

FIG. 1 is a block diagram showing a basic architecture of the television with a built-in digital video recording device according to the present invention.

FIG. 2 is a block diagram showing architecture of the television with a built-in digital video recording device according to the present invention.

### DETAILED DESCRIPTION OF THE INVENTION

The present invention integrates a television, a monitor, and a digital video recorder into a unitary device with triplex functions a television with a built-in digital video recording device, which has amusement, security monitoring, and digital video recording functions simultaneously. The television had full functions equipped with the NTSC/PAL all regions Tuner unit or fulfill the local message to support close caption in USA or Teletext in Europe as a completed align with Digital broadcasting development to built in the future as a completed TV system.

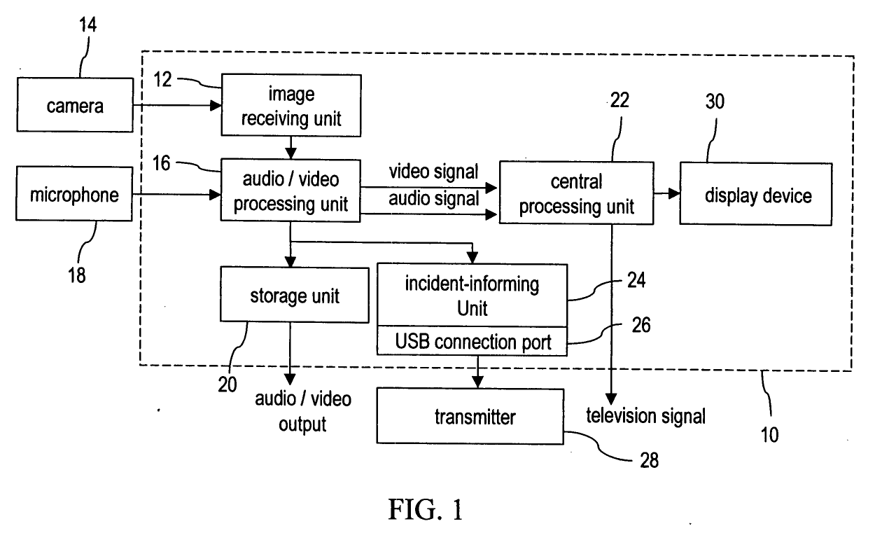

Refer to FIG. 1 a block diagram showing a basic architecture of the television with a built-in digital video recording device according to the present invention. The television with a built-in digital video recording device 10 of the present invention includes: an image receiving unit 12, receiving and processing digital images from one or a plurality of external cameras 14 installed at monitored sites, such as entrances and exits; an audio/video processing unit 16 coupled to the image receiving unit 12, receiving the digital images from monitored sites, compressing, partitioning the digital images, and outputting video signals, wherein the audio/video processing unit 16 may also receive the audio signals picked up by microphones 18, which are installed at the same sites as the cameras 14; a storage unit 20 coupled to the audio/video processing unit 16, storing the audio and video signals processed by the audio/video processing unit 16, and outputting audio/video signals, wherein the storage unit 20 may be an image-storage hard disc drive and may output audio/video signals; a central processing unit 22 coupled to the audio/video processing unit 16, receiving and processing external television signals or the audio/video signals from the audio/video processing unit 16; an backup notice unit 24 coupled to the audio/video processing unit 16, coupled to a transmitter 28 via a USB connection port 26, sending out an incident message via the transmitter 28 when there is an incident occurring; and a display device 30, presenting the sound and images of the audio/video signals or the television signals, which are processed by the central processing unit 22, wherein the display device may be an LCD device. The user may utilize the USB connection port 26 to download the captured special event period from the instored HDD storage device easily. The display device 30 is a flat panel display device, such ad the liquid crystal display device or the Plasma Display Board.

When the user chooses to watch a television program, the central processing unit 22 receives external television signals and presents it on the display device 30. When the user chooses to watch security-monitoring images, the central processing unit 22 switches off the television signals and presents the images and sound of the real-time audio/video signals, which are received by the audio/video processing unit 16, on the display device 30. Thus, television with a built-in digital video recording device 10 of the present invention functions not only as an amusement device but also as a security monitor.

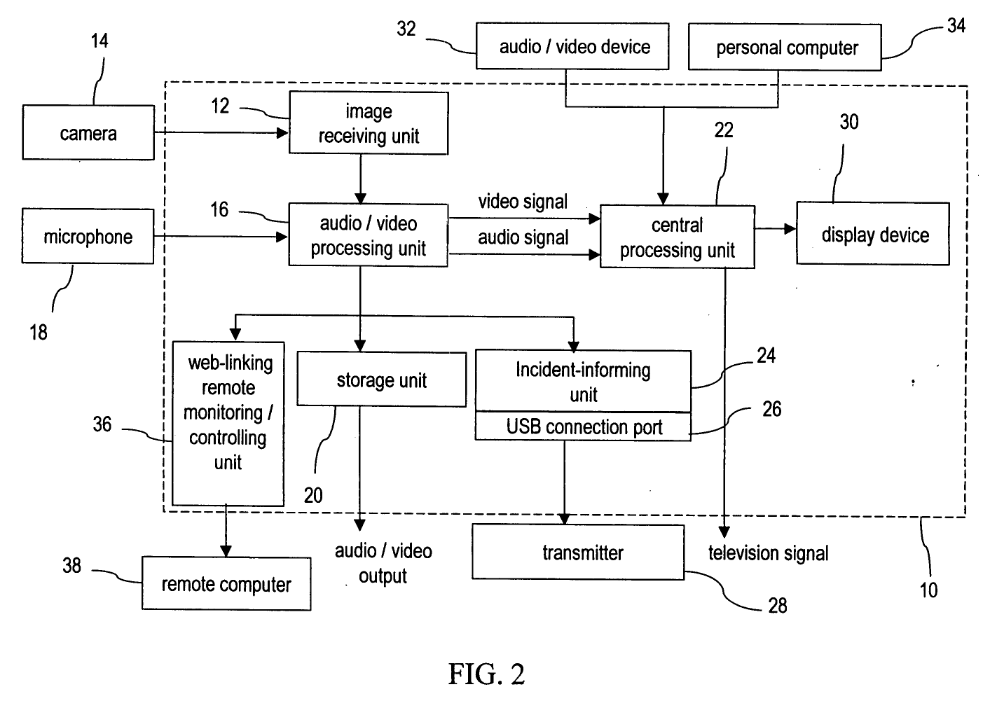

Refer to FIG. 2. In the present invention, the central processing unit 22 may also receive audio/video signals from other audio/video devices 32 or computer signals from a personal computer 34. Further, for implementing distal-end monitoring and controlling, the television with a built-in digital video recording device 10 of the present invention may also have a web-linking remote monitoring/controlling software unit 36 coupled to the audio/video processing unit 16 and linked to a remote computer 38 via a wired or wireless method, such as the Internet, a LAN (Local Area Network), or a wireless network.

As the television with a built-in digital video recording device of the present invention is a triplex device integrating three devices into a unitary one, it not only has small size and high space efficiency but also can be easily and rapidly installed; moreover, the user may assemble it by himself, and thus, the installation expense can also be saved.

The embodiments described above are only intended to clarify the technical thoughts and characteristics of the present invention so that the persons skilled in the art can understand, make and use the present invention but not to limit the scope of the present invention. Any equivalent modification and variation according to the spirit of the present invention disclosed herein is to be included within the scope of the claims of the present invention.

What is claimed is:

1. A television with a built-in digital video recording device, which may be coupled to at least one camera, the television with a built-in digital video recording device comprising:
an image receiving unit, receiving and processing digital images from said camera;
an audio/video processing unit, coupled to said image receiving unit, receiving, compressing, partitioning said digital images to output video signals;
at least one storage unit, coupled to said audio/video processing unit and storing said video signals;
a central processing unit, coupled to said audio/video processing unit, and receiving and processing said video signals and external television signals; and
a display device, coupled to said central processing unit and presenting the images of said video signals or said television signals.

2. The television with a built-in digital video recording device according to claim 1, wherein said audio/video processing unit further receives audio signals from external microphones, compresses said audio signals, and outputs audio signals to said central processing unit for, on said display device, displaying the images of said video signals in combination of the sound of said audio signals.

3. The television with a built-in digital video recording device according to claim 1, further comprising a web-linking remote monitoring/controlling software unit coupled to said audio/video processing unit and linked to a remote computer with said web-linking remote monitoring/controlling unit via a wired or wireless method.

4. The television with a built-in digital video recording device according to claim 3, wherein said web-linking remote monitoring/controlling unit is linked to said remote computer via the internet, a local area network, or a wireless network.

5. The television with a built-in digital video recording device according to claim 1, further comprising an backup notice unit coupled to said audio/video processing unit and provided with a connection port to couple to a transmitter.

6. The television with a built-in digital video recording device according to claim 5, wherein said connection port is an USB (Universal Serial Bus) connection port.

7. The television with a built-in digital video recording device according to claim 1, wherein said central processing unit receives audio/video signals from other audio/video devices or computer signals from at least one computer.

8. The television with a built-in digital video recording device according to claim 1, wherein said display device is a flat panel display device.

9. The television with a built-in digital video recording device according to claim 1, wherein said storage unit is an image-storage hard disc drive (HDD).
